(19) United States
(12) Patent Application Publication
(10) Pub. No.: US 2013/0246191 A1
(43) Pub. Date: Sep. 19, 2013

(54) BID AGENT POOL

(71) Applicants: Vaishali Angal, Sunnyvale, CA (US); Eric Bax, Altadena, CA (US); Ayman Farahat, San Francisco, CA (US); Patrick R. Jordan, Mountain View, CA (US); Chris Leggetter, Belmont, CA (US)

(72) Inventors: Vaishali Angal, Sunnyvale, CA (US); Eric Bax, Altadena, CA (US); Ayman Farahat, San Francisco, CA (US); Patrick R. Jordan, Mountain View, CA (US); Chris Leggetter, Belmont, CA (US)

(73) Assignee: Yahoo! Inc., Sunnyvale, CA (US)

(21) Appl. No.: 13/423,887

(22) Filed: Mar. 19, 2012

(51) Int. Cl. G06Q 30/02; G06Q 30/08

(52) U.S. Cl. 705/14.71

(57) ABSTRACT

Techniques are provided which improve performance of bid agents on online advertising exchanges. Methods and systems elicit an advertiser's goals for an online advertising campaign. One or more bid agents are selected to be included in a bid program based at least in part on the goals. Each of the bid agents is matched to one or more goals, and each of the bid agents is configured to calculate a bid for an ad call based at least in part on predetermined rules. One or more parameters of the selected bid agents are set based at least in part on marketplace conditions in an online advertising exchange.

### BACKGROUND

In online advertising auctions, online advertisers or their representatives purchase opportunities to advertise, also known as ad calls, from online publishers or their representatives. Exchanges for online advertising host these auctions. The buyers express targeting constraints and bidding rules and formulas using bid agents. Targeting constraints determine whether a bid agent submits a hid for each ad call. When a bid agent submits a bid for an ad call, bidding rules and formulas determine the amount of the bid. As the exchange receives ad calls from sellers, it selects the highest submitted bid, and awards the ad call to the corresponding buyer.

Different online advertisers have different goals or combinations of goals. One advertiser may aim to maximize reach, meaning that as many different people as possible see their ads, subject to a budget constraint. Another may aim to maximize net profit from selling items online or offline. Yet another may aim to spur discussion of their brand or products in online forums.

Targeting constraints and bidding rules and formulas may be based on a variety of ad call features. Some features correspond to the user who will experience the ad, including their demographics such as age and gender, their location, and sometimes category labels based on their search, browsing, and/or buying history. Other features may include information about the publisher, the content that will accompany the ad, and the device that will display the ad, such as a standard computer, tablet, or mobile phone.

With so many different combinations of goals and features, it is a challenge for buyers to develop effective bid agents. There is a need for techniques which allow buyers to achieve improved performance from bid agents.

### SUMMARY

Exemplary embodiments of the invention provide systems and methods which allow improved performance of bid agents. In some embodiments, an advertiser's goals for an online advertising campaign may be elicited. Different online advertisers have different goals or combinations of goals. For example, one advertiser may aim to maximize reach, which involves maximizing the number of people that see their ads. Another may aim to maximize net profit from selling items online or offline. Yet another may aim to spur discussion of their brand or products in online forums.

One or more bid agents may be selected to be included in a bid program based at least in part on the goals, wherein each of the bid agents is matched to one or more goals, and each of the bid agents is configured to calculate a bid for an ad call. The bid agents may be specialized for particular goals. For example, one bid agent may be used to calculate a bid if the buyer's goal is to maximize reach. Another bid agent may be used to calculate a bid if the buyer's goal is to maximize sales. The bid program may include one or more bid agents, and each of the bid agents may calculate a bid for the ad call.

One or more parameters of the selected bid agents may be set based at least in part on marketplace conditions in an online advertising exchange. For example, the bid agent's targeting constraints, or budget constraints may be set. The bid agents may submit their bids to a bid controller included in the bid program, and the bid controller may compute a final bid for the ad call using at least the bids calculated by the bid agents. The bid program may then submit the final bid in an auction, hosted by the advertising exchange, for the ad call.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a flow diagram illustrating a method according to one embodiment of the invention.

### DETAILED DESCRIPTION

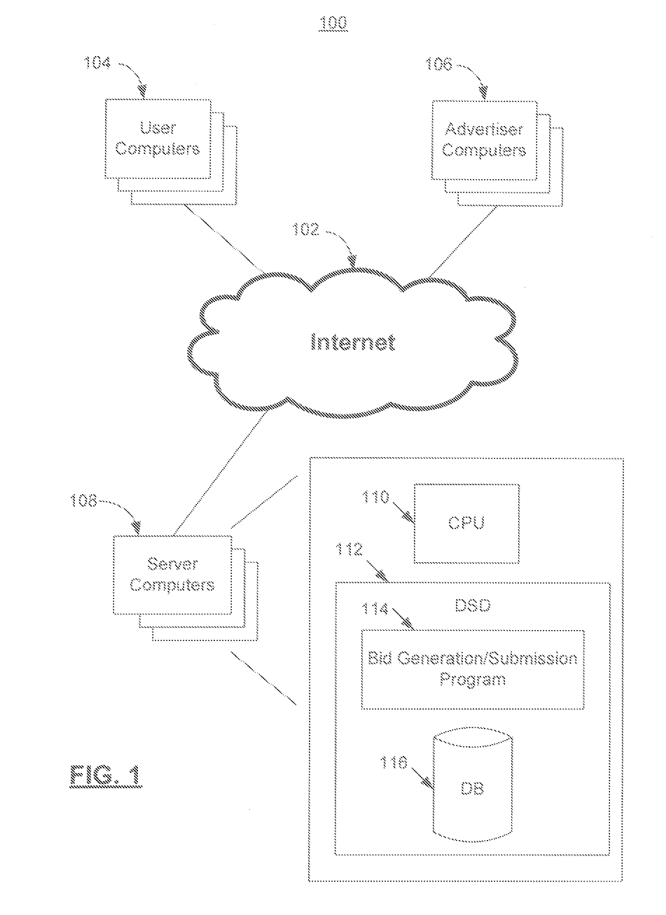

FIG. 1 is a distributed computer system 100 according to one embodiment of the invention. The system 100 includes user devices 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user devices 104 may be or include smart televisions (e.g., televisions with internet connectivity), non-smart televisions, set-top boxes, gaming consoles, desktop or laptop PCs, as well as, wireless, mobile, or handheld devices such as cell phones (including smart phones), PDAs, tablets, etc.

Each of the one or more computers 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Bid Generation/Submission. Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

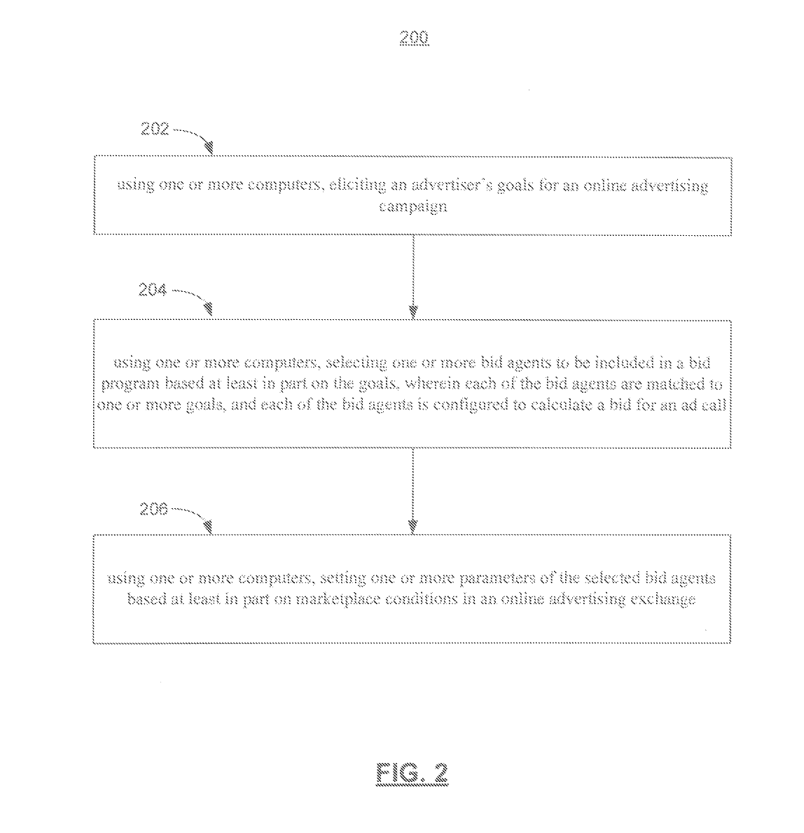

FIG. 2 is a flow diagram illustrating a method 200 according to one embodiment of the invention. At step 202 using one or more computers, an advertiser's goals for an online advertising campaign may be elicited. Different online advertisers have different goals or combinations of goals. For example, one advertiser may aim to maximize reach, which involves maximizing the number of people that see their ads. Another may aim to maximize net profit from selling items online or offline. Yet another may aim to spur discussion of their brand or products in online forums.

At step 204, using one or more computers, one or more bid agents may be selected to be included in a bid program based at least in part on the goals, wherein each of the bid agents is matched to one or more goals, and each of the bid agents is configured to calculate a bid for an ad call. The bid agents may be specialized for particular goals. For example, one bid agent may be used to calculate a bid if the buyer's goal is to maximize reach. Another bid agent may be used to calculate a bid if the buyer's goal is to maximize sales. The bid program may include one or more bid agents, and each of the bid agents may calculate a bid for the ad call. The bid agents may submit their bids to a bid controller included in the bid program, and the bid controller may compute a final bid for the ad call using at least the bids calculated by the bid agents. The bid program may then submit the final bid in an auction, hosted by the advertising exchange, for the ad call.

In accordance with one embodiments, bid agents may be owned by the advertising exchange, the buyer, the seller, or a third party. The owner may charge for use of the bid agents. The owner may pay buyers for data on performance vs goals in order to improve the bid agents. Similarly, the owner may charge less to use bid agents if buyer is willing to share performance data. Alternatively, the owner may charge more if buyer is unwilling to share performance data. In some embodiments, experimentation techniques may be used to determine which agents to use for a campaign. Alternatively, or in addition, passive analysis (on subsets of bought ad calls that also would have been bought by candidate agents), active analysis (controlled experiments using candidate agents), or a regression-based approach may be used to determine which agents to select for a campaign. A variety of methods may be used to combine agents for multiple goals. For example, multiple agents with each allocated a portion of budget or of ad calls bought may be used. As another example, agents may weight features, e.g. bid 2× for older users, and agents may be combined by averaging the weights. Bid agents' performance may be compared to a baseline to determine the charge for using agents.

At step 206, using one or more computers, one or more parameters of the selected bid agents may be set based at least in part on marketplace conditions in an online advertising exchange. For example, the bid agent's targeting constraints, or budget constraints may be set.

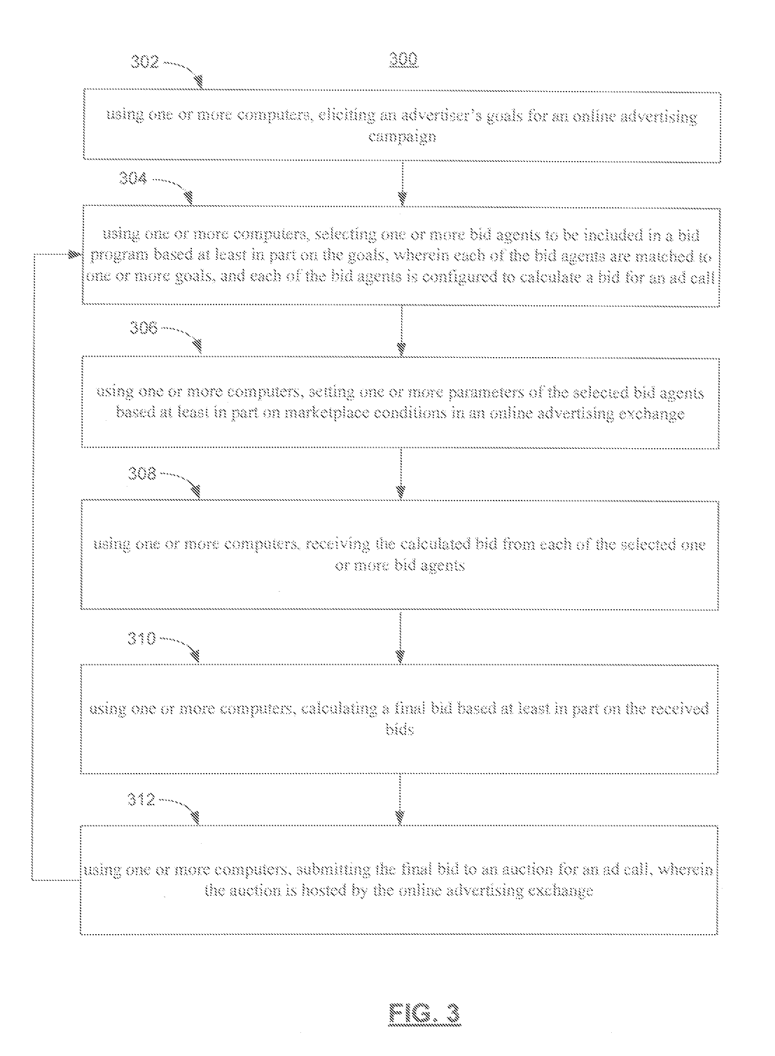

FIG. 3 is a flow diagram illustrating a method 300 according to one embodiment of the invention. At step 302 using one or more computers, an advertiser's goals for an online advertising campaign may be elicited.

At step 304, using one or more computers, one or more bid agents may be selected to be included in a bid program based at least in part on the goals, wherein each of the bid agents are matched to one or more goals, and each of the bid agents is configured to calculate a bid for an ad call. At step 306, using one or more computers, one or more parameters of the selected bid agents may be set based at least in part on marketplace conditions in an online advertising exchange. At step 308, using one or more computers, the calculated bid from each of the selected one or more bid agents may be received by the bid program.

The bid agents may submit their bids to a bid controller included in the bid program, and the bid controller may compute a final bid for the ad call using at least the bids calculated by the bid agents. At step 310, using one or more computers, a final bid may be calculated based at least in part on the received bids. At step 312, using one or more computers, the final bid may be submitted to an auction for an ad call, wherein the auction is hosted by the online advertising exchange. As the bid program bids on and buys ad calls, performance data is collected. The performance data are presented to the advertiser, either summarized in reports or directly. Examples of performance metrics that may be collected or measured include online sales increase, offline sales increase, amount of budget spent, clickthrough rate, conversion rate, rate of being forwarded by users, amount of online discussion generated by ad, polling to determine increase in awareness, affinity, and/or education, reach, frequency distribution, etc.

The advertiser may assess the data, and as a result, the advertiser may decide to alter their goals from those that were derived in the initial goal discernment step. Changes in goals may produce changes to initial targeting and the optimization problem, which may lead to changes in the agent types used in the bid program. New agents may be added to the bid program or agents may be removed from the bid program based on performance analysis and/or advertiser reassessment of goals. When these changes occur, the agent fusion process (described in more detail below) is used to update the bid program. The system itself may analyze the performance data. This analysis may indicate that some agent contracts, produce inaccurate estimates. As a result, the agent contracts (described in more detail below) may be altered. Then agent fusion may be re-applied to reflect these changes in the bid program.

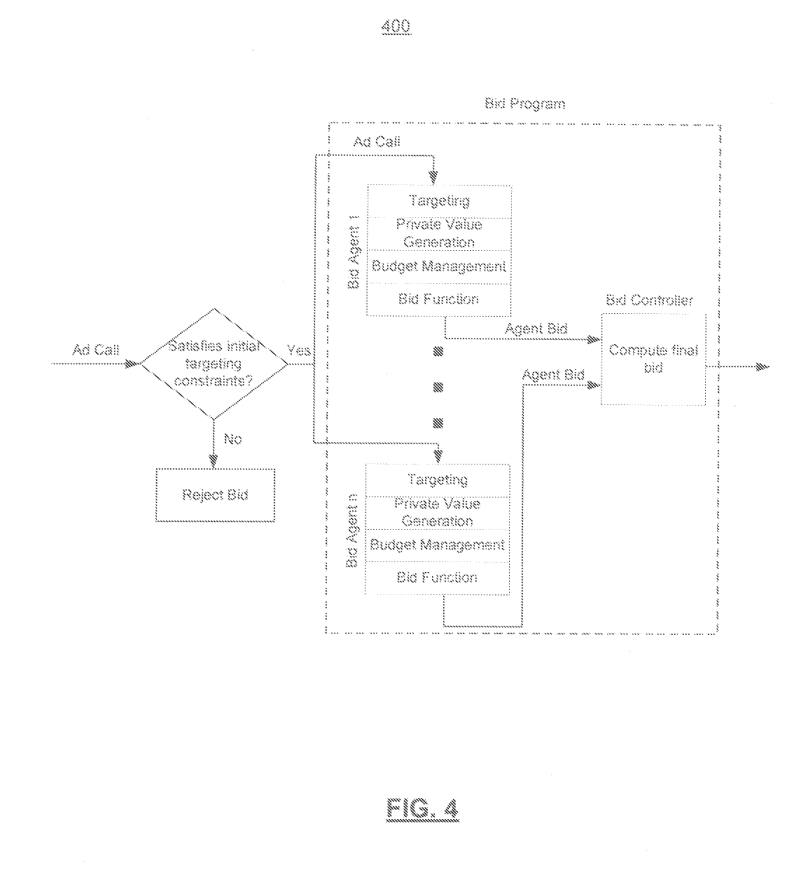

FIG. 4 is a block diagram illustrating one embodiment of the invention. As depicted in FIG. 4, the bid program generates a final bid for an ad call. Initially, the bid program may apply its initial targeting constraints. If the ad call satisfies the initial targeting constraints, then it is sent to the bid agents. The bid program may include one or more bid agents, as shown in FIG. 4. If the ad call does not satisfy the targeting constraints, then the ad call is rejected.

Each bid agent may apply its own targeting constraints, if any. Targeting constraints (used by both bid agents and the bid program as initial targeting constraints) may include, for example, demographics, location, search history, browsing history, buying history, user proclivity to click, user proclivity to convert, user-declared interests, third-party data segments, behavioral targeting segments, content category, publisher, etc. A bid agent may value the ad call based on the bid agent's goals and generate a private value for the ad call. For example, if a bid agent has the goal of maximizing clickthrough rate, then the agent may estimate the likelihood of a click if the advertiser's ad is shown in response to the ad call. The agent may also employ budget management to avoid spending more than its allocated budget. The agent may generate a hid for the ad call based on the private value and the budget.

The bid agents may submit their bids to a bid controller, which may compute a final bid for the ad call based at least in part on the bids received from each of the bid agents. For example, the bid controller may take the maximum agent bid as its bid. The hid controller then issues the bid to the auction for the ad call. If the ad call is won, then the charge is attributed to the agent that submitted the maximum bid, and the charge is subtracted from the agent's budget. In case of a tie, the charge may be attributed to one of the agents that submitted tied maximum bids, selected at random, or the charge may be shared across agents.

In some instances, there may be a time delay between winning an ad call and determining the charge. For example, the charge may be based on whether a user who clicks on the ad subsequently completes an online purchase in the next two weeks. In these cases, estimated charges may be subtracted from agent budgets initially, and the charges may be corrected as actual charges become available.

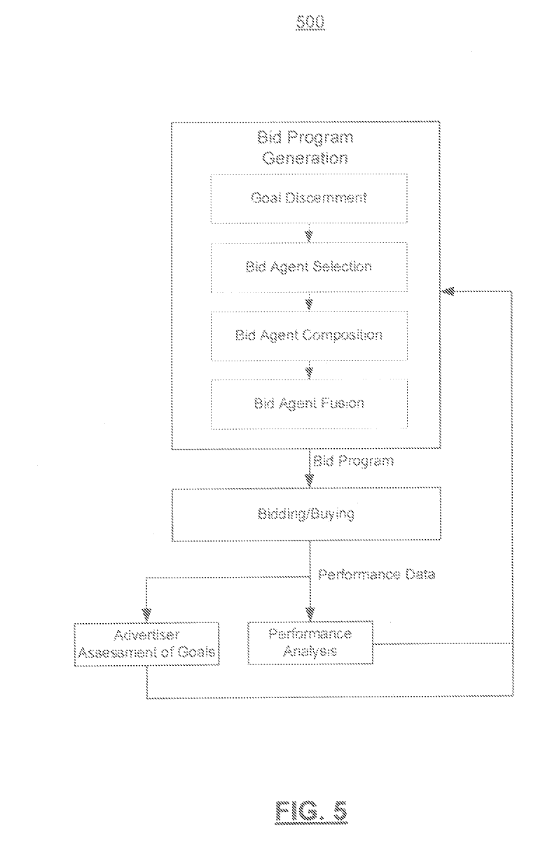

FIG. 5 is a block diagram 500 illustrating how a bid program is generated and updated in accordance with one embodiment of the invention. As depicted in FIG. 5, an advertiser's goals for an advertising campaign may be discerned or elicited, and based on the goals and the advertiser's product type, initial targeting constraints, and other factors or constraints to optimize may be determined. For example, an advertiser with a campaign to drive in-store traffic may want to limit their advertising to users in states that have their stores, so the initial targeting constraints would include geographic constraints to rule out ad calls from users outside those states. The advertiser's product type and other information regarding the advertiser's products may be used to select appropriate bid agents.

The bid program may determine additional constraints and an objective to optimize based on the advertiser's goals. The objective may be a mixed objective, such as a weighted combination of number of ad calls bought and clickthrough rate. The constraints may be prioritized, so that if there is no feasible solution with all constraints, the lower-priority constraints can be dropped until a feasible solution is found. The objective and constraints form an optimization problem.

In the bid agent selection step, bid agents may be selected based at least in part on the advertiser's goals. The agents may also be selected based at least in part on historical data on the effectiveness of agent types for advertisers in the past that had similar initial targeting, optimization problems, and product types or industries.

In the bid agent composition step, bid agent parameters relating to private value generation, budget management methods, and bid functions may be set based on the advertiser's initial targeting, bid agent type, and optimization factors. Once the hid agent parameters are set, bid agent contracts may he produced. A bid agent contract is a function from bid agent parameters to estimated outcomes that map to variables in the optimization problem. For example, an agent contract may express a function that maps the budget for the agent to estimated impressions that the agent will buy in a specified time period by spending that budget. Agent contracts may express levels of statistical uncertainty about estimated outcomes as well as the estimated outcomes themselves. For example, agent contracts may express estimated mean impressions to be bought and estimated standard deviation of impressions to be bought.

In the agent fusion step, bid agents are configured to solve the optimization problem. The fusion process operates on agent contracts and the optimization problem to determine parameter settings for agents such that their contracts estimate that together, the bid agents will optimize for the objective function of the optimization problem while operating within its constraints. For example, the agent fusion process may allocate budget over agents such that their contracts indicate they will solve the optimization problem. In this case, one agent contract may indicate that one agent will buy some number of impressions per budget allocated, and another agent contract may indicate that another agent will produce some number of clicks per budget allocated. If the optimization problem is to maximize clicks given that at least some number of impressions are bought, then the agent fusion process allocates enough budget to the first agent to buy sufficient impressions and may allocate the remaining budget to the other agent to maximize clicks.

More generally, the agent fusion step may be based on portfolio optimization techniques. Agent contracts may indicate mean and variance of outcomes in proportion to budget allocated to the agents. The optimization problem may have a utility function that balances maximizing an outcome with minimizing its variance. In this case, standard portfolio allocation techniques from financial investing can be used to allocate budget among agents as if they were investments. Alternatively, quadratically constrained quadratic program (QCQP) optimization techniques may be used, or backpropagation may be used.

Once the bid program is formed, the program may be used to bid on ad calls. As the bid program bids on and buys ad calls, performance data is collected. Some performance data may be presented to the advertiser, either summarized in reports or directly. Examples of performance metrics that may be collected or measured include online sales increase, offline sales increase, amount of budget spent, clickthrough rate, conversion rate, rate of being forwarded by users, amount of online discussion generated by ad, polling to determine increase in awareness, affinity, and/or education, reach, frequency distribution, etc.

The advertiser may assess the data, and as a result, the advertiser may decide to alter their goals from those that were derived in the initial goal discernment step. Changes in goals may produce changes to initial targeting and the optimization problem, which may lead to changes in the agent types used in the bid program. New agents may be added to the bid program or agents may be removed from the bid program based on performance analysis and/or advertiser reassessment of goals. When these changes occur, the agent fusion process is used to update the bid program. The system itself may analyze the performance data. This analysis may indicate that some agent contracts produce inaccurate estimates. As a result, the agent contracts may be altered. Then agent fusion may be re-applied to reflect these changes in the bid program.

As data accumulates from multiple advertiser campaigns, that data can be used to evaluate and improve the effectiveness of individual agent types and to improve the accuracy of estimates in agent contracts.

In accordance with an exemplary embodiment, a method to adjust bid agent parameters and bid controller parameters, for bid agent fusion and subsequent tuning, will now be described. To support the method, the optimization problem may be transformed into a bid program utility function. The bid program utility function maps from advertising outcomes such as impressions, clicks, conversions, spending, and metrics on reach and frequency to a value that indicates the effectiveness of the bid program. In general, the bid program utility function may have a term or terms to represent the objective function from the optimization problem, and the bid program utility function may also have terms that express that bid program effectiveness decreases when constraints from the optimization problem are not satisfied. For example, suppose the optimization problem is to buy as many impressions as possible while maintaining some minimum rate of conversions per impression. Then the bid program utility function may have a term that increases with the number of impressions bought and another term that decreases with the gap between the specified minimum conversion rate and the actual conversion rate. Part of goal discernment may be to establish weights to express the relative importance of the objective function and each of the constraints, so those weights can be applied to the corresponding terms in the bid program utility function.

There is a chain of influence from bid agent parameters to the bid program utility function, as follows. The agent bid function takes agent parameters as inputs and produces agent bids as outputs. The agent bids are inputs to the bid controller function, which outputs bid program bids to the auction. The auction takes bid program bids as inputs and outputs decisions on whether the bid program wins the ad calls. Winning ad calls leads to advertising outcomes, including impressions, clicks, conversions, and spending. The bid program utility function takes advertising outcomes as inputs and produces as outputs values that indicate the bid program's effectiveness.

To set or adjust bid agent parameters, the method uses gradient descent methods, which require values or estimates of how the bid program utility function value changes as a function of changes in bid agent parameters. These changes may be expressed as partial derivatives or partial differences in bid program utility function value with respect to bid agent parameters. Backpropagation can be used to combine values or estimates of partial derivatives or differences of outputs with respect to ‘inputs along each link in the chain of influence to compute or estimate the partials of bid program utility function value with respect to bid agent parameters. This process is similar to methods to train artificial neural networks.

A similar process can be used to set or adjust bid controller parameters. For these parameters, the chain of influence begins with the parameters as inputs to the bid controller function. The chain then joins the chain outlined earlier, proceeding from bid program bids to auction wins and losses to advertising outcomes to bid program utility function values.

While the invention is described with reference to the above drawings, the drawings are intended to be illustrative, and the invention contemplates other embodiments within the spirit of the invention.

1. A method comprising:
using one or more computers, eliciting an advertiser's goals for an online advertising campaign;
using one or more computers, selecting one or more bid agents to be included in a bid program based at least in part on the goals, wherein each of the bid agents are matched to one or more goals, and each of the bid agents is configured to calculate a bid for an ad call; and
using one or more computers, setting one or more parameters of the selected bid agents based at least in part on marketplace conditions in an online advertising exchange.

2. The method of claim 1, further comprising:
using one or more computers, adjusting the parameters of one or more of the selected bid agents based at least in part on one or more performance metrics.

3. The method of claim 1, further comprising:
using one or more computers, adjusting the parameters of one or more of the selected bid agents based at least in part on goals modified by the advertiser.

4. The method of claim 1, further comprising:
using one or more computers, adding one or more bid agents to the bid program based at least in part on performance metrics.

5. The method of claim 1, further comprising:
using one or more computers, removing one or more bid agents from the bid program based at least in part on performance metrics.

6. The method of claim 1, further comprising:
using one or more computers, receiving the calculated bid from each of the selected one or more bid agents;
using one or more computers, calculating a final bid based at least in part on the received bids; and
using one or more computers, submitting the final bid to an auction for an ad call, wherein the auction is hosted by the online advertising exchange.

7. The method of claim 1, wherein a bid agent is configured to calculate the bid based at least in part on a predetermined budget.

8. The method of claim 6, further comprising:
using one or more computers, charging the bid agent that provided the highest bid for the ad call if the final bid is accepted for the ad call; and
using one or more computers, subtracting the charge from the budget.

9. The method of claim 1, further comprising:
using one or more computers, using QCQP or backpropagation to configure bid agent parameters.

10. A system comprising:
one or more server computers coupled to a network; and
one or more databases coupled to the one or more server computers;
wherein the one or more server computers are for:
eliciting an advertiser's goals for an online advertising campaign;
selecting one or more bid agents to be included in a bid program based at least in part on the goals, wherein each of the bid agents are matched to one or more goals, and each of the bid agents is configured to calculate a bid for an ad call; and
setting one or more parameters of the selected bid agents based at least in part on marketplace conditions in an online advertising exchange.

11. The system of claim 10, wherein the one or more server computers are further configured for:
adjusting the parameters of one or more of the selected bid agents based at least in part on one or more performance metrics.

12. The system of claim 10, wherein the one or more server computers are further configured for:
adjusting the parameters of one or more of the selected bid agents based at least in part on goals modified by the advertiser.

13. The system of claim 10, wherein the one or more server computers are further configured for:
adding one or more bid agents to the bid program based at least in part on performance metrics.

14. The system of claim 10, wherein the one or more server computers are further configured for:
removing one or more bid agents from the bid program based at least in part on performance metrics.

15. The system of claim 10, wherein the one or more server computers are further configured for:
receiving the calculated bid from each of the selected one or more bid agents;
calculating a final bid based at least in part on the received bids; and
submitting the final bid to an auction for an ad call, wherein the auction is hosted by the online advertising exchange.

16. The system of claim 10, wherein a bid agent is configured to calculate the bid based at least in part on a predetermined budget.

17. The system of claim 15, wherein the one or more server computers are further configured for:
charging the bid agent that provided the highest bid for the ad call if the final bid is accepted for the ad call; and
subtracting the charge from the budget.

18. The system of claim 10, wherein the one or more server computers are further configured for:
configuring bid agent parameters using QCQP or backpropagation.

19. The system of claim 10, wherein a bid agent is configured to calculate a private value for an ad call, and wherein the agent is configured to calculate the bid based at least in part on the private value.

20. A computer readable medium or media containing instructions for executing a method comprising:
using one or more computers, eliciting an advertiser's goals for an online advertising campaign;
using one or more computers, selecting one or more bid agents to be included in a bid program based at least in part on the goals, wherein each of the bid agents are matched to one or more goals, and each of the bid agents is configured to calculate a bid for an ad call;
using one or more computers, setting one or more parameters of the selected bid agents based at least in part on marketplace conditions in an online advertising exchange;
using one or more computers, receiving the calculated bid from each of the selected one or more bid agents;
using one or more computers, calculating a final bid based at least in part on the received bids; and
using one or more computers, submitting the final bid to an auction for an ad call, wherein the auction is hosted by the online advertising exchange.
